(19) United States
(12) Patent Application Publication
(10) Pub. No.: US 2020/0187034 A1
(43) Pub. Date: Jun. 11, 2020

(54) Measurement Signal Transmission Method and Network Device

(71) Applicant: Huawei Technologies Co., Ltd., Shenzhen (CN)

(72) Inventors: Yiru Kuang, Beijing (CN); Jian Wang, Beijing (CN); Yongbo Zeng, Beijing (CN); Haibo Xu, Beijing (CN)

(21) Appl. No.: 16/333,178

(22) PCT Filed: Sep. 14, 2016
(86) PCT No.: PCT/CN2016/099068

§ 371 Date: Mar. 13, 2019

(51) Int. Cl. H04W 24/10; H04L 5/00; H04B 17/318

(52) U.S. Cl. CPC H04W 24/10; H04L 5/0053; H04L 5/0094; H04B 17/318; H04L 5/0048

(57) ABSTRACT

A measurement signal transmission method and apparatus, and a network device are disclosed. The method includes the following steps: determining a physical resource block used to deploy a measurement signal, where the physical resource block is a subset of all physical resource blocks in frequency domain corresponding to a channel bandwidth of user equipment; determining a physical resource corresponding to the physical resource block; and transmitting the measurement signal to the user equipment by using the physical resource, where the measurement signal is used by the user equipment to measure channel information. Optionally, the method further includes: sending a resource indication message to the user equipment, where the resource indication message indicates the physical resource block occupied for deploying the measurement signal and/or the physical resource occupied for transmitting the measurement signal.

### CROSS-REFERENCE TO RELATED APPLICATIONS

This application is a national stage of International Application No. PCT/CN2016/099068, filed on Sep. 14, 2016, which is hereby incorporated by reference in its entirety.

### TECHNICAL FIELD

The present invention relates to the field of communications technologies, and in particular, to a measurement signal transmission method and a network device.

### BACKGROUND

A reference signal (RS) is a known signal that is provided by a transmit end for a receive end and that is used for channel estimation or channel sounding. A downlink reference signal is a signal that is provided by a base station for user equipment (UE) and that is used for downlink channel estimation or measurement. The downlink reference signal includes a cell-specific reference signal (CRS). The cell-specific reference signal may be used to demodulate a downlink control channel, and may be further used to perform downlink channel measurement. A downlink channel measurement result is a key indicator for cell selection/reselection and cell handover. Currently, downlink channel measurement is performed mainly by using a CRS. A CRS is distributed on any physical resource block (PRB) on a system frequency band. To be specific, the CRS is a reference signal distributed on an entire frequency band.

A subsystem (for example, a narrowband-Internet of Things (NB-IoT)) is a technology applied to a future fifth generation mobile communications technology (5G) or a new radio access network technology (NR). The subsystem needs to be deployed on a 100 kHz channel raster. If a center frequency of a PRB or the sum of the center frequency and a particular frequency offset is an integer multiple of 100 kHz, it is considered that the PRB can be used to deploy the subsystem.

CRSs are consecutively distributed on an entire frequency band, that is, the CRS is distributed on each PRB. However, some PRBs are used to deploy the subsystem, and reference signals are undesired on the PRBs used to deploy the subsystem. As a result, deployment of the subsystem and deployment of a reference signal similar to the CRS distributed on the entire frequency band affect each other.

### SUMMARY

Embodiments of the present invention provide a measurement signal transmission method and a network device, to reduce impact between measurement signal deployment and subsystem deployment, and ensure measurement performance of a measurement signal.

A first aspect of the embodiments of the present invention provides a measurement signal transmission method, including: determining a physical resource block used to deploy a measurement signal, where the physical resource block is a subset of all physical resource blocks in frequency domain corresponding to a channel bandwidth of user equipment; determining a physical resource corresponding to the physical resource block; and transmitting the measurement signal to the user equipment by using the physical resource, where the measurement signal is used by the user equipment to measure channel information.

In the first aspect of the embodiments of the present invention, the physical resource block used to deploy the measurement signal is the subset of all the physical resource blocks in frequency domain corresponding to the channel bandwidth of the user equipment. To be specific, not all the physical resource blocks in frequency domain are used to deploy the measurement signal, and a remaining physical resource block may be used to deploy another signal or system. In this way, not only measurement performance of the measurement signal can be ensured, but also a probability that measurement signal deployment and subsystem deployment occupy a same physical resource block can be reduced, thereby reducing impact between measurement signal deployment and subsystem deployment.

In a possible implementation, the method further includes: sending a resource indication message to the user equipment, where the resource indication message indicates the physical resource block occupied for deploying the measurement signal and/or the physical resource occupied for transmitting the measurement signal. The user equipment is informed, by using the resource indication message, of a specific physical resource block on which the measurement signal is deployed, so that the user equipment searches for the measurement signal on the corresponding physical resource block. The user equipment is informed, by using the resource indication message, of a specific physical resource used to transmit the measurement signal, so that the user equipment searches for a corresponding physical resource block based on the physical resource, to obtain the measurement signal.

In a possible implementation, the resource indication message is a primary synchronization signal PSS, and a root sequence of the PSS indicates the physical resource block occupied for deploying the measurement signal and/or the physical resource occupied for transmitting the measurement signal. It may be understood that different root sequences indicate different deployment manners of the measurement signal, and the deployment manner is represented by using the occupied physical resource block.

In a possible implementation, the resource indication message is a broadcast message, and the broadcast message indicates the physical resource block occupied for deploying the measurement signal and/or the physical resource occupied for transmitting the measurement signal. Specifically, the physical resource block and/or the physical resource may be indicated by using a resource indication bit in the broadcast message. Different values of the resource indication bit indicate different deployment manners, and the deployment manner is represented by using the occupied physical resource block.

In a possible implementation, the physical resource block used to deploy the measurement signal is determined based on a physical resource block occupied for deploying a subsystem. To be specific, the physical resource block occupied by the subsystem is avoided or a probability that the subsystem and the measurement signal occupy a same physical resource block is reduced, thereby avoiding or reducing impact between measurement signal deployment and subsystem deployment.

In a possible implementation, the physical resource block includes at least two physical resource blocks at consecutive locations, and it indicates that the measurement signal occupies consecutive physical resource blocks.

In a possible implementation, the physical resource block includes at least two physical resource blocks at evenly-spaced locations, and it indicates that physical resource blocks occupied by the measurement signal are non-consecutive. It may be understood as that numbers of the occupied physical resource blocks are in an arithmetic progression.

In a possible implementation, the channel information includes at least one of reference signal received power RSRP, a received signal strength indicator RSSI, and reference signal received quality RSRQ.

A second aspect of the embodiments of the present invention provides a network device, including: a processor, configured to determine a physical resource block used to deploy a measurement signal, where the physical resource block is a subset of all physical resource blocks in frequency domain corresponding to a channel bandwidth of user equipment, where the processor is further configured to determine a physical resource corresponding to the physical resource block; and a transmitter, configured to transmit the measurement signal to the user equipment by using the physical resource, where the measurement signal is used by the user equipment to measure channel information.

The network device provided in the second aspect of the embodiments of the present invention is configured to implement the measurement signal transmission method provided in the first aspect of the embodiments of the present invention, and details are not described herein again.

A third aspect of the embodiments of the present invention provides a computer storage medium, configured to store a computer software instruction used by the foregoing network device. The computer software instruction includes a program designed for performing the foregoing aspect.

In the embodiments of the present invention, the physical resource block used to deploy the measurement signal is determined, and the physical resource block is the subset of all the physical resource blocks in frequency domain corresponding to the channel bandwidth of the user equipment; the physical resource corresponding to the physical resource block is determined; and the measurement signal is transmitted to the user equipment by using the physical resource, and the measurement signal is used by the user equipment to measure the channel information. This avoids that measurement signal deployment and subsystem deployment occupy a same physical resource block, or reduces a probability that measurement signal deployment and subsystem deployment occupy a same physical resource block, thereby reducing impact between measurement signal deployment and subsystem deployment, and ensuring measurement performance of the measurement signal.

### BRIEF DESCRIPTION OF THE DRAWINGS

To describe the technical solutions in the embodiments of the present invention or in the prior art more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of a possible network architecture according to an embodiment of the present invention;

FIG. 2 is a table of mapping between a channel bandwidth and a quantity of physical resource blocks;

FIG. 3 is a schematic flowchart of a measurement signal transmission method according to an embodiment of the present invention;

FIG. 4 is a table of comparison between physical resource blocks used to deploy a subsystem;

FIG. 5a is a table of comparison between physical resource blocks used to deploy a measurement signal;

FIG. 5b is another table of comparison between physical resource blocks used to deploy a measurement signal;

FIG. 5c is still another table of comparison between physical resource blocks used to deploy a measurement signal;

FIG. 6a is a schematic diagram of consecutive deployment of a measurement signal;

FIG. 6b is a schematic diagram of evenly-spaced deployment of a measurement signal; and

FIG. 7 is a schematic structural diagram of a network device according to an embodiment of the present invention.

### DETAILED DESCRIPTION OF ILLUSTRATIVE EMBODIMENTS

The following clearly and completely describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

Terminologies such as “component”, “module”, and “system” used in this specification are used to indicate computer-related entities, hardware, firmware, combinations of hardware and software, software, or software being executed. For example, a component may be but is not limited to a process that runs on a processor, a processor, an object, an executable file, a thread of execution, a program, and/or a computer. As shown in figures, both a computing device and an application that runs on a computing device may be components. One or more components may reside within a process and/or a thread of execution, and a component may be located on one computer and/or distributed between two or more computers. In addition, these components may be executed from various computer-readable media that store various data structures. For example, the components may communicate by using a local and/or remote process and based on, for example, a signal having one or more data packets (for example, data from two components interacting with another component in a local system, a distributed system, and/or across a network such as the Internet interacting with other systems by using the signal).

It should be understood that the technical solutions in the embodiments of the present invention may be applied to a Long Term Evolution (LTE) architecture; or may be applied to a Universal Mobile Telecommunications System (UMTS) Terrestrial Radio Access Network (UTRAN) architecture, or a Global System for Mobile Communications (GSM)/Enhanced Data Rates for GSM Evolution (EDGE) radio access network (GSM EDGE Radio Access Network, GERAN) architecture. In the UTRAN architecture or the GERAN architecture, a function of an MME is implemented by a serving general packet radio service (GPRS) support node (SGSN), and a function of an SGW\PGW is implemented by a gateway GPRS support node (GGSN). The technical solutions in the embodiments of the present invention may be further applied to another communications system, for example, a public land mobile network (PLMN) system, or even a future 5G communications system or an NR system. This is not limited in the embodiments of the present invention. Preferably, the embodiments of the present invention are applied to a future 5G communications system architecture or an NR system architecture.

The embodiments of the present invention may be applied to UE. The user equipment may communicate with one or more core networks by using a radio access network (RAN). The user equipment may include but is not limited to an access terminal, a subscriber unit, a subscriber station, a mobile station, a mobile console, a remote station, a remote terminal, a mobile device, a user terminal, a terminal, a wireless communications device, a user agent, or a user apparatus. The access terminal may be a cellular phone, a cordless phone, a Session Initiation Protocol (SIP) phone, a wireless local loop (WLL) station, a personal digital assistant (PDA), a handheld device having a wireless communication function, a computing device, another processing device connected to a wireless modem, an in-vehicle device, a mobile transportation device, a wearable device, or a terminal device in a future 5G communications system.

The embodiments of the present invention may also be applied to a network device. The network device may be a device used to communicate with user equipment. For example, the network device may be a base transceiver station (BTS) in a GSM or CDMA system, or a NodeB (NB) in a WCDMA system; or may be an evolved NodeB (Evolutional Node B, eNB or eNodeB) in an LTE system, or a network side device in a future 5G communications system, a network device in an NR system.

In addition, aspects or features of the present invention may be implemented as a method, an apparatus or a product that uses standard programming and/or engineering technologies. The term “product” used in this application covers a computer program that can be accessed from any computer readable component, carrier, or medium. For example, the computer-readable medium may include but is not limited to: a magnetic storage component (for example, a hard disk, a floppy disk, or a magnetic tape), an optical disc (for example, a compact disc (CD), a digital versatile disc (DVD), a smart card and a flash memory component (for example, an erasable programmable read-only memory (EPROM), a card, a stick, or a key drive). In addition, various storage media described in this specification may represent one or more devices and/or other machine-readable media used to store information. The term “machine-readable medium” may include but is not limited to a radio channel, and various other media that can store, contain, and/or carry an instruction and/or data.

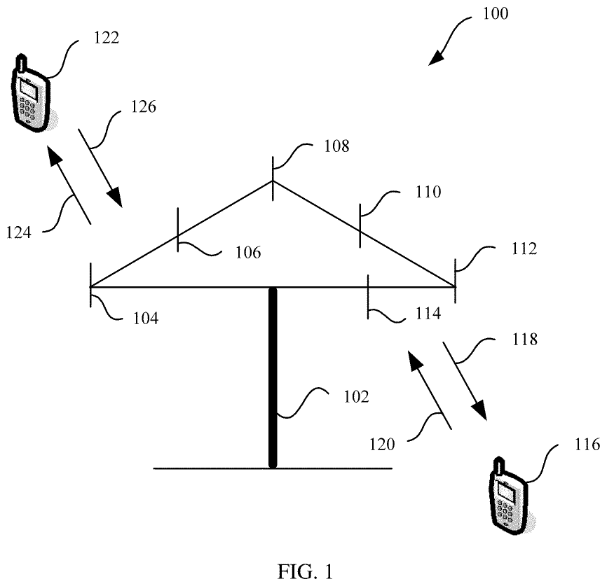

FIG. 1 is a schematic diagram of a possible network architecture according to an embodiment of the present invention. As shown in FIG. 1, the network architecture 100 includes a network device 102, and the network device 102 may include a plurality of antennas, for example, antennas 104, 106, 108, 110, 112, and 114. In addition, the network device 102 may additionally include a transmitter chain and a receiver chain. A person of ordinary skill in the art may understand that the transmitter chain and the receiver chain each may include a plurality of components (for example, a processor, a modulator, a multiplexer, a demodulator, a demultiplexer, or an antenna) related to signal sending and receiving.

The network device 102 may communicate with a plurality of user equipments (for example, user equipment 116 and user equipment 122). However, it may be understood that the network device 102 may communicate with any quantity of user equipments similar to the user equipment 116 or the user equipment 122. For example, the user equipment 116 and the user equipment 122 each may be a cellular phone, a smartphone, a portable computer, a handheld communications device, a handheld computing device, a satellite radio apparatus, a global positioning system, a PDA, an in-vehicle device, and/or any other suitable device configured to perform communication in the wireless communications system 100.

As shown in FIG. 1, the user equipment 116 communicates with the antennas 112 and 114. The antennas 112 and 114 send information to the terminal device 116 by using a forward link 118, and receive information from the user equipment 116 by using a reverse link 120. In addition, the user equipment 122 communicates with the antennas 104 and 106. The antennas 104 and 106 send information to the user equipment 122 by using a forward link 124, and receive information from the user equipment 122 by using a reverse link 126.

It should be understood that the embodiments of the present invention may be applied to downlink transmission, for example, 118 and 124 shown in FIG. 1. That is, the network device 122 transmits a measurement signal to the user equipment. FIG. 1 is a simplified schematic diagram of an example. The network may further include another network device that is not shown in FIG. 1.

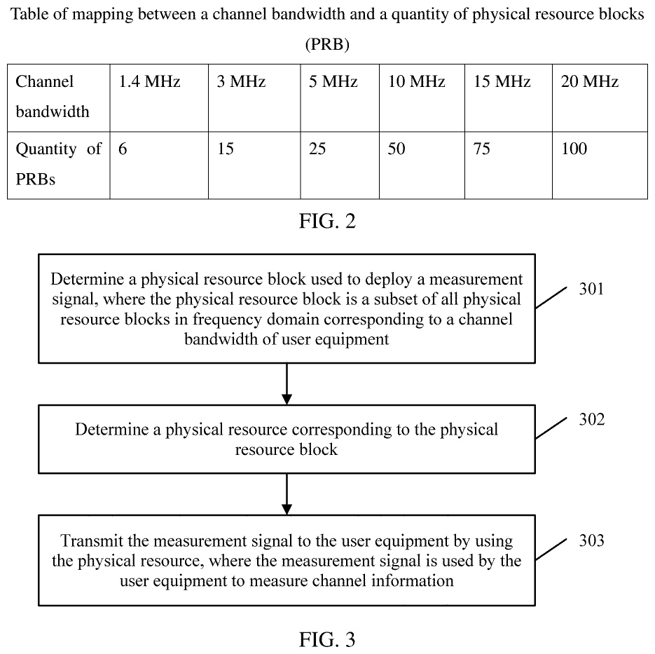

The network device 122 shown in FIG. 1 may further configure, for the user equipment 116 or 122 or another user equipment, a channel bandwidth and a system resource corresponding to the channel bandwidth. The channel bandwidth means limiting a lower limit frequency and an upper limit frequency at which a signal is allowed to pass the channel, that is, limiting a frequency passband. When there is a subsystem in a future 5G communications system or an NR system, the channel bandwidth may be a primary system bandwidth. The network device 122 may further configure a subcarrier spacing for the user equipment 116 or 122, and determine, based on the channel bandwidth and the subcarrier spacing, the system resource corresponding to the channel bandwidth, and further configure the system resource corresponding to the channel bandwidth. The system resource corresponding to the channel bandwidth may be all physical resource blocks in frequency domain corresponding to the channel bandwidth, that is, a total quantity of physical resource blocks in frequency domain. It should be noted that all physical resource blocks in the embodiments of the present invention are physical resource blocks in frequency domain. Referring to FIG. 2, FIG. 2 is a table of mapping between a channel bandwidth and a quantity of physical resource blocks (PRB). It should be noted that the mapping table shown in FIG. 2 is a mapping table corresponding to a case in which the subcarrier spacing is 15 kHz. If the subcarrier spacing is not 15 kHz, a correspondence between a channel bandwidth and a quantity of PRBs is different from that in FIG. 2. In a cellular communications system or an LTE system, each PRB includes 12 subcarriers.

Currently, a CRS used for downlink channel measurement is distributed on any PRB on a system frequency band. For example, a channel bandwidth is 3 MHz, a subcarrier spacing is 15 kHz, and a CRS is distributed on each of 15 PRBs corresponding to the channel bandwidth.

In the future 5G communications system or the NR system, there are some new designs and requirements. Each NR subcarrier may support a plurality of basic parameters (numerology) designed in an orthogonal frequency division multiplexing system. The numerology may include a subcarrier spacing, a cyclic prefix length, a transmission time interval length, a channel bandwidth, and the like. A downlink subcarrier spacing in the future 5G communications system or the NR system is 15 kHz, or 2ⁿ times as large as 15 kHz, for example, 120 kHz or 150 kHz. For various numerologies, subsystem deployment may be supported. A subsystem may include but is not limited to a narrowband-Internet of Things. The subsystem needs to be deployed on a 100 kHz channel raster. If a center frequency of a PRB or the sum of the center frequency and a particular frequency offset is an integer multiple of 100 kHz, it is considered that the PRB can be used to deploy the subsystem.

The CRS is distributed on each PRB. However, some PRBs are used to deploy the subsystem, and reference signals are undesired on the PRBs used to deploy the subsystem. As a result, deployment of the subsystem and deployment of a reference signal similar to the CRS distributed on an entire frequency band affect each other.

To avoid or reduce the impact between deployment of the subsystem and deployment of the reference signal similar to the CRS distributed on the entire frequency band, the embodiments of the present invention provide a measurement signal and a measurement signal transmission method, to avoid or reduce impact of measurement signal deployment on subsystem deployment, and ensure measurement performance of the measurement signal. The measurement signal is used by user equipment to measure channel information, that is, implement a measurement function of a CRS. In addition, the measurement signal has forward compatibility. In other words, the measurement signal is compatible with a farther communications system such as the future 5G communications system, the NR system, or a future sixth generation mobile communications technology (6G). However, the measurement signal is not a reference signal distributed on an entire frequency band. It should be noted that a name of the measurement signal constitutes no limitation to the embodiments of the present invention. The embodiments of the present invention further provide a network device, configured to implement the measurement signal transmission method.

With reference to FIG. 3 to FIG. 5, the measurement signal transmission method provided in the embodiments of the present invention is described below in detail.

Referring to FIG. 3, FIG. 3 is a schematic flowchart of a measurement signal transmission method according to an embodiment of the present invention. The method may include the following steps.

301. Determine a physical resource block used to deploy a measurement signal, where the physical resource block is a subset of all physical resource blocks in frequency domain corresponding to a channel bandwidth of user equipment.

Specifically, any network device may configure a channel bandwidth for each user equipment in coverage of the network device. When there is a subsystem, the channel bandwidth may be a primary system bandwidth.

The network device configures, for the user equipment, the channel bandwidth and a system resource corresponding to the channel bandwidth. The system resource corresponding to the channel bandwidth is all physical resource blocks in frequency domain corresponding to the channel bandwidth. In a possible implementation, the network device further configures a subcarrier spacing for the user equipment; determines, based on the channel bandwidth and the subcarrier spacing, the system resource corresponding to the channel bandwidth; and further configures, for the user equipment, the system resource corresponding to the channel bandwidth. If the subcarrier spacing is 15 kHz, the network device may configure, for the user equipment based on the mapping table that is shown in FIG. 2 and that is between a channel bandwidth and a quantity of PRBs, a quantity of PRBs corresponding to the channel bandwidth.

When or after configuring the channel bandwidth and the system resource corresponding to the user equipment, the network device configures, in the system resource corresponding to the user equipment, a physical resource block used to deploy a subsystem or a physical resource block used to deploy other signals than the measurement signal and the subsystem. Subsystem deployment is used as an example below for description.

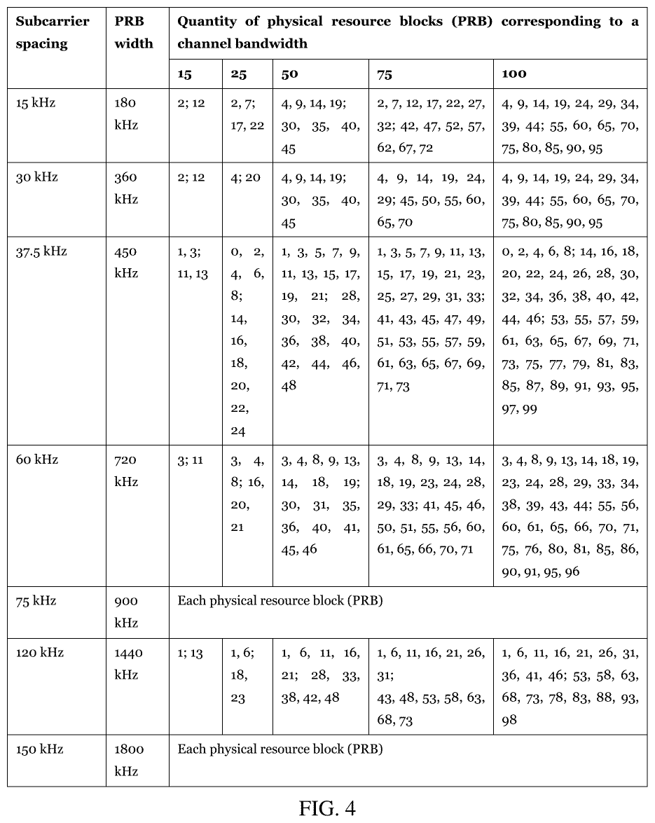

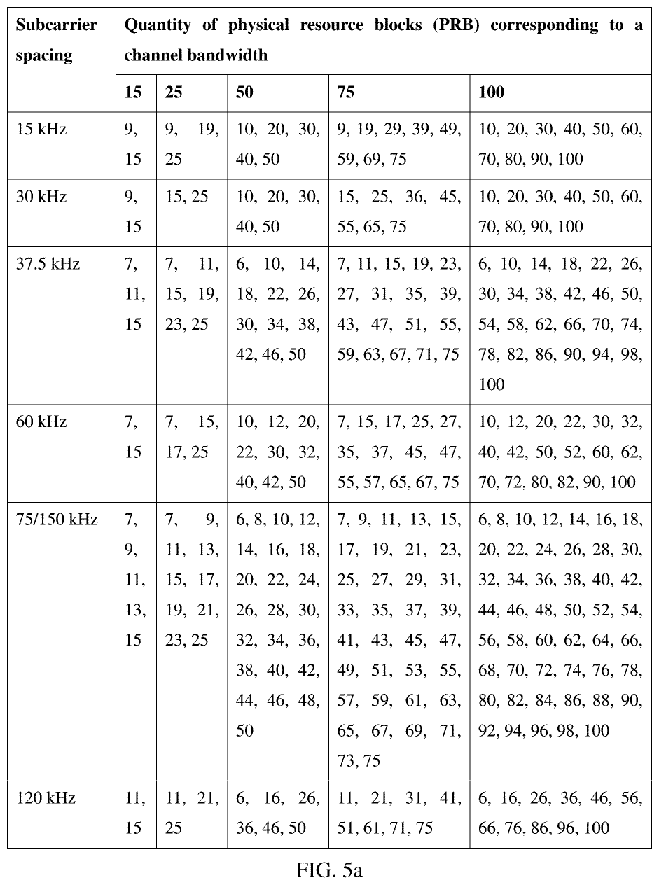

Because the subsystem needs to be deployed on a 100 kHz channel raster, only some PRBs meeting the condition can be used to deploy the subsystem. A center frequency of each PRB is calculated. If a center frequency of a PRB or the sum of the center frequency of the PRB and a particular frequency offset is an integer multiple of 100 kHz, it is considered that the PRB can be used to deploy the subsystem. A future 5G communications system or an NR system may support a plurality of numerologies, that is, support a plurality of subcarrier spacings. Therefore, a table that is shown in FIG. 4 and that is of comparison between physical resource blocks used to deploy the subsystem is obtained, through calculation, for the plurality of subcarrier spacings and quantities of PRBs corresponding to a plurality of channel bandwidths. The comparison table shown in FIG. 4 describes a number of (the number starts from 0) of an occupied PRB in a case of each quantity of PRBs and each of the plurality of subcarrier spacings. That the subcarrier spacing is 15 kHz and the quantity of PRBs corresponding to the channel bandwidth is 15 is used as an example. Because one PRB includes 12 subcarriers, a PRB width is 180 kHz. In this case, PRBs that may be used to deploy the subsystem are represented as (2; 12). To be specific, PRBs numbered 2 and 12 in the 15 PRBs may be used to deploy the subsystem. It should be noted that the subsystem may be deployed on each of the PRBs numbered 2 and 12, or may be deployed on either of the PRBs numbered 2 and 12, or may be deployed on neither of the PRBs numbered 2 and 12. That the subcarrier spacing is 37.5 kHz and the quantity of PRBs corresponding to the channel bandwidth is 15 is used as an example. In this case, a PRB width is 450 kHz, and PRBs that may be used to deploy the subsystem are (1; 3; 11; 13). To be specific, PRBs numbered 1, 3, 11, and 13 in the 15 PRBs may be used to deploy the subsystem. It should be noted that the subsystem may be deployed on one or more of the four PRBs or on each of the four PRBs, or may be deployed on none of the four PRBs.

With reference to the channel bandwidth and the subcarrier spacing, the network device may configure, in the system resource corresponding to the user equipment and based on the comparison table shown in FIG. 4, the physical resource block used to deploy the subsystem. Zero physical resource block or one or more physical resource blocks may be used to deploy the subsystem.

The network device determines the physical resource block used to deploy the measurement signal, and the physical resource block is the subset of all the physical resource blocks in frequency domain corresponding to the channel bandwidth. Optionally, the network device determines, based on the physical resource block occupied for deploying the subsystem, a physical resource used to deploy the measurement signal, to avoid that measurement signal deployment and subsystem deployment occupy a same physical resource block, or reduce a probability that measurement signal deployment and subsystem deployment occupy a same physical resource block, thereby avoiding or reducing impact between measurement signal deployment and subsystem deployment.

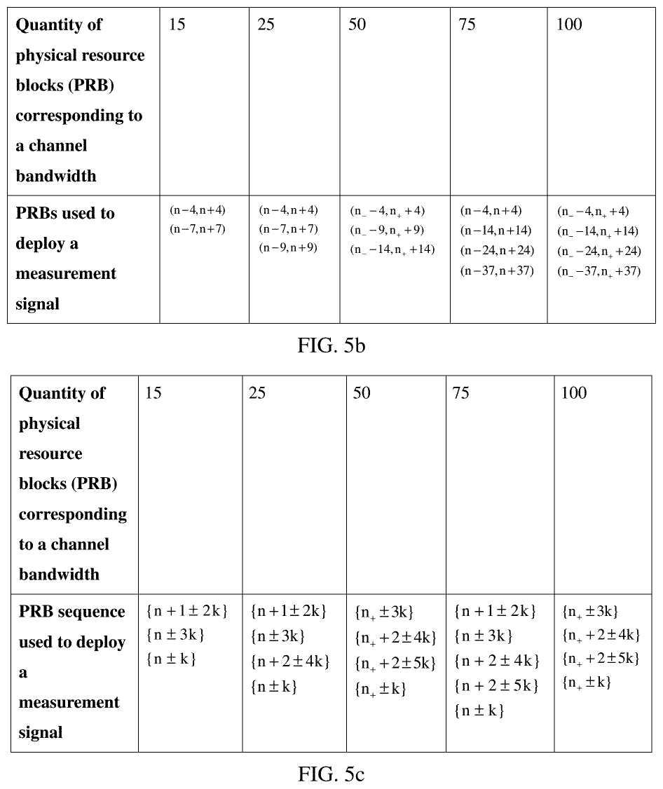

In a possible implementation, the physical resource block used to deploy the measurement signal includes at least two physical resource blocks at consecutive locations. Consecutive locations indicate that resources extending from the middle to two sides of the system resource are continuous without a spacing. Location continuity may be understood as that PRB numbers are continuous. A table, shown in FIG. 5a, of comparison between physical resource blocks used to deploy the measurement signal may be obtained through induction and construction based on the table, shown in FIG. 4, of comparison between physical resource blocks used to deploy the subsystem. The comparison table shown in FIG. 5a describes a quantity of consecutive PRBs that may be used to deploy the measurement signal in a case of each subcarrier spacing and each quantity of PRBs. That the subcarrier spacing is 15 kHz and the quantity of PRBs corresponding to the channel bandwidth is 15 is used as an example. PRBs that may be used to deploy the measurement signal correspond to (9, 15), 9 indicates that the measurement signal may occupy nine consecutive PRBs, in the 15 PRBs, extending from the middle to the two sides, and 15 indicates that the measurement signal may occupy the 15 consecutive PRBs. When the subsystem occupies the PRB numbered 2 and/or the PRB numbered 12, the measurement signal may occupy nine consecutive PRBs numbered 3 to 11. When the subsystem is not deployed, the measurement signal may occupy the 15 consecutive PRBs numbered 0 to 14. FIG. 5a lists a relatively large quantity of cases, and complexity is relatively high. Therefore, several representative cases are extracted from the comparison table shown in FIG. 5a, to construct another table, shown in FIG. 5b, of comparison between physical resource blocks used to deploy the measurement signal. In FIG. 5b, if the quantity of PRBs corresponding to the channel bandwidth is an odd number, n represents a middle PRB in the PRBs corresponding to the channel bandwidth. For example, the quantity of PRBs corresponding to the channel bandwidth is 15, the middle PRB is an eighth PRB (a PRB numbered 7), PRBs that may be used to deploy the measurement signal are (n−4,n+4), and (n−4,n+4) indicates that the PRBs that may be used to deploy the measurement signal are nine consecutive PRBs extending from the middle to the two sides, namely, nine consecutive PRBs numbered 3 to 11. (n−7,n+7) indicates that the PRBs that may be used to deploy the measurement signal are 15 consecutive PRBs extending from the middle to the two sides. If the quantity of PRBs corresponding to the channel bandwidth is an even number, n₋ and n₊ represent two middle PRBs in the PRBs corresponding to the channel bandwidth. For example, the quantity of PRBs corresponding to the channel bandwidth is 50, the two middle PRBs are a 25^{th} PRB (a PRB numbered 24) and a 26^{th} PRB (a PRB numbered 25), PRBs that may be used to deploy the measurement signal are (n₋−4,n₊+4), and (n₋−4,n₊+4) indicates that the PRBs that may be used to deploy the measurement signal are 10 consecutive PRBs extending from the middle to the two sides, namely, ten consecutive PRBs numbered 20 to 29. (n₋−9,n₊+9) indicates that the PRBs that may be used to deploy the measurement signal are 20 consecutive PRBs extending from the middle to the two sides, namely, 20 consecutive PRBs numbered 15 to 34. (n₋−14,n₊+14) indicates that the PRBs that may be used to deploy the measurement signal are 30 consecutive PRBs extending from the middle to the two sides, namely, 10 consecutive PRBs numbered 10 to 39.

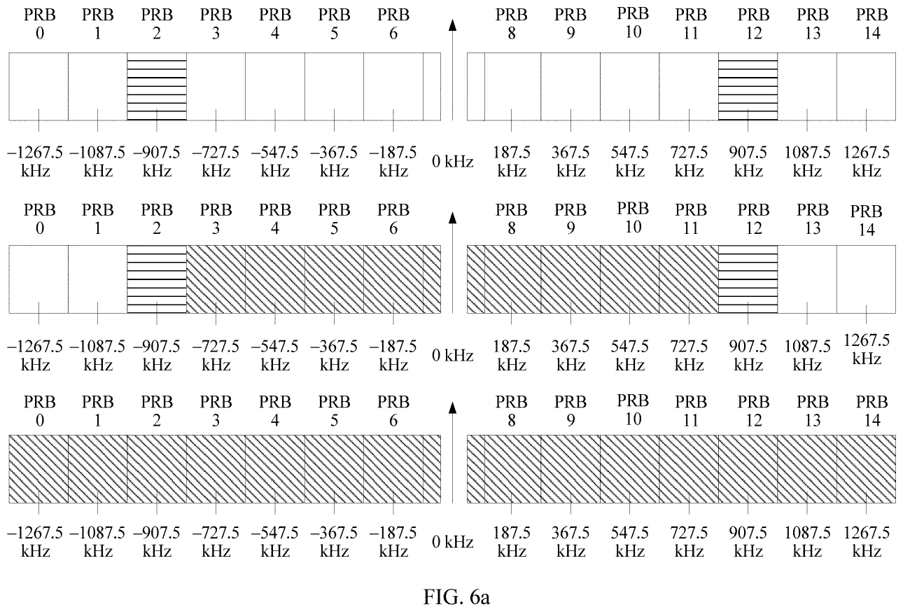

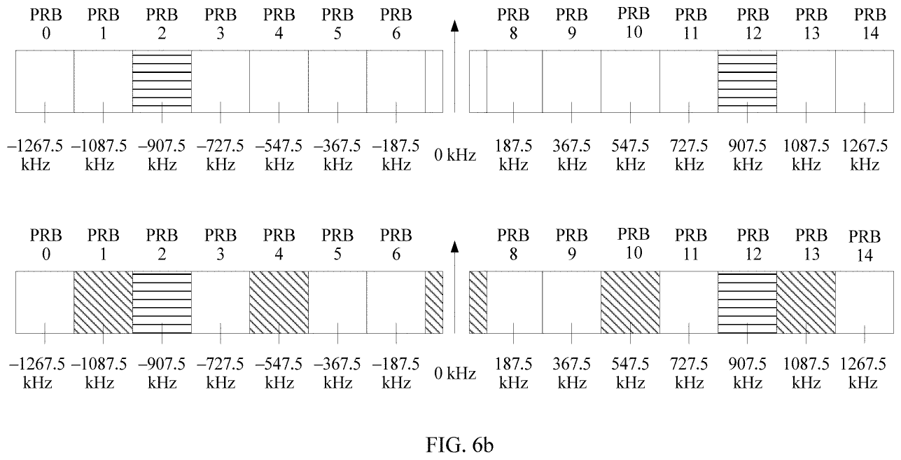

Referring to FIG. 6a, FIG. 6a is a schematic diagram of consecutive deployment of a measurement signal. In FIG. 6a, an example in which the quantity of PRBs corresponding to the channel bandwidth is 15 is used. A center frequency of the PRB numbered 2 is −907.5 kHz, a center frequency of the PRB numbered 12 is 907.5 kHz, a frequency offset is ±7.5, and an integer multiple of 100 kHz is met. Therefore, the subsystem can be deployed on each of the two PRBs. If the subsystem is deployed on each of the PRBs numbered 2 and 12, namely, PRBs marked with horizontal stripes in a first line and a second line in FIG. 6a, the measurement signal may be deployed on each of nine consecutive PRBs numbered 3 to 11, namely, PRBs marked with oblique stripes in the second line in FIG. 6a. If the subsystem is not deployed on each of the 15 PRBs, the measurement signal may be deployed on each of the 15 consecutive PRBs, namely, the PRBs marked with oblique stripes in a third line in FIG. 6a.

In another possible implementation, the physical resource block used to deploy the measurement signal includes at least two physical resource blocks at evenly-spaced locations. That locations are evenly spaced may be understood as that PRB numbers are discontinuous. Still another table, shown in FIG. 5c, of comparison between physical resource blocks used to deploy the measurement signal may be obtained through induction and construction based on the table, shown in FIG. 4, of comparison between physical resource blocks used to deploy the subsystem. The comparison table shown in FIG. 5c describes a PRB sequence that may be used to deploy the measurement signal in a case of each subcarrier spacing and each quantity of PRBs. In FIG. 5c, k=0, 1, 2, . . . . If the quantity of PRBs corresponding to the channel bandwidth is an odd number, n represents a middle PRB in the PRBs corresponding to the channel bandwidth. For example, the quantity of PRBs corresponding to the channel bandwidth is 15, the middle PRB is an eighth PRB (a PRB numbered 7), the PRB sequence that may be used to deploy the measurement signal is {n+1±2k}, and {n+1±2k} indicates that the PRBs that may be used to deploy the measurement signal are PRBs numbered 0, 2, 4, 6, 8, 10, 12, and 14. {n±3k} indicates that the PRBs that may be used to deploy the measurement signal are PRBs numbered 1, 4, 7, 10, and 13. If the quantity of PRBs corresponding to the channel bandwidth is an even number, n₋ and n₊ represent two middle PRBs in the PRBs corresponding to the channel bandwidth. For example, the quantity of PRBs corresponding to the channel bandwidth is 50, the two middle PRBs are a 25^{th} PRB (a PRB numbered 24) and a 26^{th} PRB (a PRB numbered 25), and the PRB sequence that may be used to deploy the measurement signal is {n₊±3k}. There is a relatively large amount of data, and the data are not listed herein one by one. It may be understood that a corresponding PRB sequence indicates that numbers of PRBs are in an arithmetic progression, and the PRBs that may be used to deploy the measurement signal are deployed in an evenly-spaced manner (deployed in a shape of a comb).

Referring to FIG. 6b, FIG. 6b is a schematic diagram of evenly-spaced deployment of a measurement signal. In FIG. 6b, an example in which the quantity of PRBs corresponding to the channel bandwidth is 15 is used. The subsystem is deployed on each of the PRBs numbered 2 and 12, namely, PRBs marked with horizontal stripes in a first line and a second line in FIG. 6b. Based on the PRB sequence {n±3k}, the measurement signal may be deployed on each of the PRBs numbered 1, 4, 7, 10, and 13, namely, PRBs marked with oblique stripes in FIG. 6a. It can be learned that the measurement signal is deployed, in an evenly-spaced manner, on a PRB interleaved with a PRB used to deploy the subsystem, and evenly-spaced deployment may be considered as comb-shaped deployment.

302. Determine a physical resource corresponding to the physical resource block.

Specifically, the network device maps, according to a mapping relationship between a PRB and a resource element (RE), the physical resource block used to deploy the measurement signal, and determines the mapped physical resource. The physical resource is used to transmit the measurement signal. The resource element is a basic unit of the physical resource.

303. Transmit the measurement signal to the user equipment by using the physical resource, where the measurement signal is used by the user equipment to measure channel information.

Specifically, after deploying the measurement signal on the physical resource blocks, the network device may transmit the measurement signal to the user equipment by using the physical resource. To be specific, the physical resource is used as a carrier of the measurement signal for transmission to the user equipment.

Before or after transmitting the measurement signal, the network device may further send a resource indication message to the user equipment. The resource indication message indicates the physical resource block occupied for deploying the measurement signal and/or the physical resource occupied for transmitting the measurement signal. The user equipment is informed, by using the resource indication message, of a specific physical resource block on which the measurement signal is deployed, so that the user equipment searches for the measurement signal on the corresponding physical resource block. The user equipment is informed, by using the resource indication message, of a specific physical resource used to transmit the measurement signal, so that the user equipment searches for a corresponding physical resource block based on the physical resource, to obtain the measurement signal. The resource indication message indicates both the physical resource block and the physical resource, so that the user equipment quickly obtains the measurement signal.

It should be noted that a deployment manner in the following specification is a manner in which the measurement signal occupies a PRB, including consecutive occupation and evenly-spaced occupation. Consecutive occupation is represented by using a quantity of consecutive PRBs, and evenly-spaced occupation is represented by using an evenly-spaced PRB sequence.

In a possible implementation, the resource indication message is a primary synchronization signal (PSS). The PSS includes a root sequence, and the root sequence indicates the physical resource block occupied for deploying the measurement signal and/or the physical resource occupied for transmitting the measurement signal. In LTE, different cells are distinguished from each other at a physical layer by using physical cell IDs (Physical Cell Identities, PCI). There are 504 physical cell IDs in total, the 504 physical cell IDs are divided into 168 different groups (marked as N_{ID}⁽¹⁾ and ranging from 0 to 167), and each group includes three different intra-group identifiers (marked as N_{ID}⁽²⁾ and ranging from 0 to 2). Therefore, the physical cell ID (marked as N_{ID}^{cell}) may be obtained through calculation according to a formula PCI=N_{ID}^{cell}=3N_{ID}⁽¹⁾+N_{ID}⁽²⁾. A secondary synchronization signal (Secondary Synchronization Signal, SSS) is used to transmit an intra-group ID, namely, a value of N_{ID}⁽¹⁾. A specific method is as follows: An eNB generates two index values by using a value of a group ID N_{ID}⁽¹⁾, introduces a value of the intra-group ID N_{ID}⁽²⁾, and performs encoding to generate two sequences whose lengths are both 31, and maps the sequences to REs corresponding to the SSS. UE may learn, by performing blind detection on the sequences, a sequence currently delivered by the eNB, and therefore obtain N_{ID}⁽¹⁾ of a current cell. The PSS is used to transmit an intra-group ID, namely, a value of N_{ID}⁽²⁾. A specific method is as follows: The eNB associates a value of the intra-group ID N_{ID}⁽²⁾ with a root sequence index u, performs encoding to generate a ZC sequence dᵤ(n) whose length is 62, and maps the sequence to an RE corresponding to the PSS. The UE may learn N_{ID}⁽²⁾ of a current cell by performing blind detection on the sequence. The ZC sequence dᵤ(n) and a table of association between the value of N_{ID}⁽²⁾ and the root sequence index u are shown below:

| N_{ID}⁽²⁾ | Root sequence index^{u} |
|---|---|
| 0 | 25 |
| 1 | 29 |
| 2 | 34 |

$${d}_{u} ( n ) = \{ \begin{matrix}{e}^{- j \frac{π un ( n + 1 )}{63}} & n = 0 , 1 , … , 30 \\ {e}^{- j \frac{π u ( n + 1 ) ( n + 2 )}{63}} & n = 31 , 32 , … , 61\end{matrix}$$

For example, the eNB associates a value 1 of N_{ID}⁽²⁾ with a root sequence index 29, performs encoding to generate a ZC sequence dᵤ(n) whose length is 62, and maps the sequence to the RE corresponding to the PSS. The UE may learn, by performing blind detection on the sequence, that a value of N_{ID}⁽²⁾ of the current cell is 1. In this embodiment of the present invention, the root sequence included in the PSS is the root sequence index, and one root sequence corresponds to one value of N_{ID}⁽²⁾ and one deployment manner.

Optionally, the deployment manner is a quantity of PRBs occupied during consecutive deployment. For a specific root sequence, a value of N_{ID}⁽²⁾, and a quantity of consecutively deployed PRBs, refer to the following table. In the following table, ±4 corresponds to a deployment manner of (n−4,n+4) or (n₋−4,n₊+4) in FIG. 5b, and indicates that nine consecutive PRBs or to consecutive PRBs are occupied; ±7 corresponds to a deployment manner of (n−7,n+7) in FIG. 5b, and indicates that 15 consecutive PRBs are occupied; +9 corresponds to a deployment manner of (n−9,n+9) or (n₋−9,n₊+9) in FIG. 5b, and indicates that 19 consecutive PRBs or 20 consecutive PRBs are occupied; ±14 corresponds to a deployment manner of (n₋−14,n₊+14) in FIG. 5b, and indicates that 30 consecutive PRBs are occupied; ±24 corresponds to a deployment manner of (n−24,n+24) or (n₋−24,n₊+24) in FIG. 5b, and indicates that 49 consecutive PRBs or 50 consecutive PRBs are occupied; and ±37 corresponds to a deployment manner of (n−37,n+37) or (n₋−37,n₊+37) in FIG. 5b, and indicates that 75 consecutive PRBs or 76 consecutive PRBs are occupied.

PRB

| N_{ID}⁽²⁾ | ±4 | ±7 | ±9 | ±14 | ±24 | ±37 |
|---|---|---|---|---|---|---|
| 0 | 25 | 31 | 47 | 57 | 71 | 83 |
| 1 | 29 | 41 | 51 | 61 | 73 | 87 |
| 2 | 34 | 43 | 53 | 67 | 79 | 89 |

For example, the root sequence included in the PSS is 25. In this case, the corresponding value of N_{ID}⁽²⁾ is 0, and the deployment manner is (n−4,n+4) or (n₋−4,n₊+4). When receiving the PSS, the user equipment obtains, through parsing, that the root sequence in the PSS is 25; and determines, based on the root sequence 25, that the deployment manner is (n−4,n+4) or (n₋−4,n₊+4). To be specific, four PRBs extend from a middle PRB of a frequency band to each of two sides of the frequency band, and the measurement signal is deployed on each of the series of consecutive PRBs. It should be noted that specific values of the root sequence in the foregoing table are used as an example for description, and constitute no limitation to this embodiment of the present invention. The network device and the user equipment both store the foregoing table, so that the user equipment can accurately learn of the deployment manner.

Optionally, the deployment manner is a PRB sequence occupied during evenly-spaced deployment. For a specific root sequence, a value of N_{ID}⁽²⁾, and a PRB sequence, refer to the following table. In the following table, +1±2k corresponds to a deployment manner of the PRB sequence {n+1±2k} in FIG. 5c; ±3k corresponds to a deployment manner of the PRB sequence {n±3k} or {n₊±3k} in FIG. 5c; +2±4k corresponds to a deployment manner of a PRB sequence {n+2±4k} or {n₊+2±4 k} in FIG. 5c; +2±5k corresponds to a deployment manner of a PRB sequence {n+2±5k} or {n₊2±5k} in FIG. 5c; and ±k corresponds to a deployment manner of a PRB sequence {n±k} or {n₊±k} in FIG. 5c.

| | PRB | | | | |
|---|---|---|---|---|---|
| N_{ID}⁽²⁾ | +1 ± 2k | ±3k | +2 ± 4k | +2 ± 5k | ± k |
| 0 | 91 | 101 | 109 | 119 | 129 |
| 1 | 93 | 103 | 111 | 123 | 131 |
| 2 | 97 | 107 | 113 | 127 | 133 |

For example, the root sequence included in the PSS is 101. In this case, the corresponding value of N_{ID}⁽²⁾ is 0, and the deployment manner is {n±3k} or {n₊±3k}. When receiving the PSS, the user equipment obtains, through parsing, that the root sequence in the PSS is 101; and determines, based on the root sequence 101, that the deployment manner is {n±3k} or {n₊±3k}. To be specific, a PRB sequence extends from a middle PRB of a frequency band to two sides of the frequency band in an evenly-spaced manner, and the measurement signal is deployed on the PRB sequence. It should be noted that specific values of the root sequence in the foregoing table are used as an example for description, and constitute no limitation to this embodiment of the present invention. The network device and the user equipment both store the foregoing table, so that the user equipment can accurately learn of the deployment manner.

In a possible implementation, the resource indication message is a broadcast message, and the broadcast message indicates the physical resource block occupied for deploying the measurement signal and/or the physical resource occupied for transmitting the measurement signal. The broadcast message includes a resource indication bit, and a value of the resource indication bit indicates the physical resource block occupied for deploying the measurement signal and/or the physical resource occupied for transmitting the measurement signal. The broadcast message may include but is not limited to a system information block (Master Information Block, MIB) message. The MIB message includes a resource indication bit, 3 bits may be used to represent the resource indication bit, and the 3 bits may represent eight possible deployment manners. The foregoing two tables respectively list six deployment manners and five deployment manners, and therefore the 3 bits may represent the deployment manners listed in the foregoing two tables. The MIB message further includes the channel bandwidth and the system resource that are configured by the network device for the user equipment. The network device may pre-determine a deployment manner corresponding to each value of the resource indication bit, for example, 001 represents ±7 or +1±2k. The MIB message is broadcast to the user equipment on a physical broadcast channel (Physical Broadcast Channel, PBCH). The user equipment receives the MIB message by using the PBCH channel, and determines, based on a value indicated by the resource indication bit, a deployment manner of the measurement signal, that is, the physical resource block occupied for deploying the measurement signal or the physical resource occupied for transmitting the measurement signal.

When receiving the resource indication information, the user equipment determines, based on the resource indication information, a PRB occupied by the measurement signal; and receives, on the corresponding PRB, the measurement signal transmitted by the network device. The user equipment measures the channel information based on the measurement signal. The channel information includes at least one of reference signal received power (RSRP), a received signal strength indicator (RSSI), and reference signal received quality (RSRQ). The RSRP is a power value of a measurement signal or a CRS received by the user equipment, and the value is a linear average of powers of a single RE in a measurement bandwidth, and reflects strength of a desired signal in a current cell. The RSSI is a linear average of powers of all signals (for example, an intra-frequency desired signal and an interference signal, adjacent-frequency interference, and thermal noise) received by the user equipment, and reflects load strength on the resource. The RSRQ is N times as large as a ratio of the RSRP to the RSSI, that is, RSRQ=N×RSRP/RSSI. N represents a quantity of REs included in the measurement bandwidth of the RSRI, and can reflect relative magnitudes of the signal and the interference.

The user equipment may measure the channel information based on the measurement signal, and may further perform fine time-frequency synchronization based on the measurement signal.

In this embodiment of the present invention, the physical resource block used to deploy the measurement signal is determined, and the physical resource block is the subset of all the physical resource blocks in frequency domain corresponding to the channel bandwidth of the user equipment; the physical resource corresponding to the physical resource block is determined; and the measurement signal is transmitted to the user equipment by using the physical resource, and the measurement signal is used by the user equipment to measure the channel information. This avoids that measurement signal deployment and subsystem deployment occupy a same physical resource block, or reduces a probability that measurement signal deployment and subsystem deployment occupy a same physical resource block, thereby reducing impact between measurement signal deployment and subsystem deployment, and ensuring measurement performance of the measurement signal.

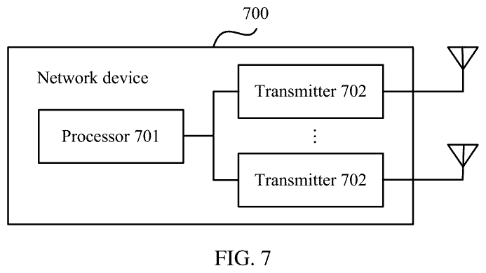

Referring to FIG. 7, FIG. 7 is a schematic structural diagram of a network device according to an embodiment of the present invention. The network device 700 includes a processor 701, a transmitter 702, and an antenna.

The processor 701 is configured to determine a physical resource block used to deploy a measurement signal, where the physical resource block is a subset of all physical resource blocks in frequency domain corresponding to a channel bandwidth of user equipment.

In specific implementation, the processor 701 is specifically configured to determine, based on a physical resource block occupied for deploying a subsystem, the physical resource block used to deploy the measurement signal.

The processor 701 is further configured to determine a physical resource corresponding to the physical resource block.

The transmitter 702 is configured to transmit the measurement signal to the user equipment by using the physical resource, where the measurement signal is used by the user equipment to measure channel information.

In a possible implementation, the transmitter 702 is further configured to send a resource indication message to the user equipment, where the resource indication message indicates the physical resource block occupied for deploying the measurement signal and/or the physical resource occupied for transmitting the measurement signal.

Optionally, the resource indication message is a primary synchronization signal PSS, and a root sequence of the PSS indicates the physical resource block occupied for deploying the measurement signal and/or the physical resource occupied for transmitting the measurement signal.

Optionally, the resource indication message is a broadcast message, and the broadcast message indicates the physical resource block occupied for deploying the measurement signal and/or the physical resource occupied for transmitting the measurement signal.

Optionally, the physical resource block includes at least two physical resource blocks at consecutive locations.

Optionally, the physical resource block includes at least two physical resource blocks at evenly-spaced locations.

Optionally, the channel information includes at least one of reference signal received power RSRP, a received signal strength indicator RSSI, and reference signal received quality RSRQ.

It should be noted that the processor 701 is configured to perform steps 301 and 302 in the embodiment shown in FIG. 3. The transmitter 702 is configured to perform step 303 in the embodiment shown in FIG. 3, and send the resource indication message to the user equipment.

The processor 701 may be a central processing unit (CPU), a general purpose processor, a digital signal processor (DSP), an application-specific integrated circuit (ASIC), a field programmable gate array (FPGA) or another programmable logic device, a transistor logic device, a hardware component, or any combination thereof. The processor may implement or execute various example logic blocks, modules, and circuits that are described with reference to content disclosed in the present invention. The processor 701 may be a combination implementing a computing function, for example, a combination including one or more microprocessors, or a combination of a DSP and a microprocessor. The processor 701 may be alternatively a controller. The processor 701 mainly includes four components: a cell controller, a voice channel controller, a signaling channel controller, and a multi-port interface used for extension. The processor 701 is responsible for management of all mobile communications interfaces, and is mainly responsible for radio channel allocation, release, and management.

The transmitter 702 may be a transceiver, a transceiver circuit, a communications module, a communications interface, or the like. The transceiver includes a receiver and a transmitter. The user equipment may transmit uplink data by using the transmitter and receive downlink data by using the receiver.

An embodiment of the present invention further provides a computer storage medium, configured to store a computer software instruction used by the network device. The computer software instruction includes a program designed for performing the foregoing aspect.

It should be noted that, to make the description brief, the foregoing method embodiments are expressed as a series of actions. However, a person skilled in the art should appreciate that the present invention is not limited to the described action sequence, because according to the present invention, some steps may be performed in other sequences or performed simultaneously. In addition, a person skilled in the art should also appreciate that all the embodiments described in this specification are embodiments as an example, and the related actions and modules are not necessarily mandatory to the present invention.

In the foregoing embodiments, the descriptions of the embodiments have respective focuses. For a part that is not described in detail in an embodiment, refer to related descriptions in other embodiments.

Steps in the method in the embodiments of the present invention may be adjusted, combined, or deleted according to an actual requirement.

Units in the apparatus in the embodiments of the present invention may be adjusted, combined, or deleted according to an actual requirement. A person skilled in the art may integrate or combine different embodiments and characteristics of different embodiments described in this specification.

With descriptions of the foregoing embodiments, a person skilled in the art may clearly understand that the present invention may be implemented by hardware, firmware or a combination thereof. When the present invention is implemented by software, the foregoing functions may be stored in a computer-readable medium or transmitted as one or more instructions or code in the computer-readable medium. The computer-readable medium includes a computer storage medium and a communications medium, where the communications medium includes any medium that enables a computer program to be transmitted from one place to another. The storage medium may be any available medium accessible to a computer. The following is used as an example but is not limited: The computer readable medium may include a random access memory (RAM), a read-only memory (ROM), an electrically erasable programmable read-only memory (EEPROM), a compact disc read-only memory (CD-ROM) or other optical disc storage, a disk storage medium or other disk storage, or any other medium that can be used to carry or store expected program code in a command or data structure form and can be accessed by a computer. In addition, any connection may be appropriately defined as a computer-readable medium. For example, if software is transmitted from a website, a server, or another remote source by using a coaxial cable, an optical fiber/cable, a twisted pair, a digital subscriber line (DSL), or wireless technologies such as infrared ray, radio, and microwave, the coaxial cable, optical fiber/cable, twisted pair, DSL, or wireless technologies such as infrared ray, radio, and microwave are included in fixation of a medium to which they belong. For example, a disk and disc used in the present invention include a compact disc (CD), a laser disc, an optical disc, a digital versatile disc (DVD), a floppy disk, and a Blu-ray disc, where the disk generally copies data by a magnetic means, and the disc copies data optically by a laser means. The foregoing combination should also be included in the protection scope of the computer-readable medium.

In conclusion, what are described above are merely examples of embodiments of the technical solutions of the present invention, but are not intended to limit the protection scope of the present invention. Any modification, equivalent replacement, or improvement made without departing from the spirit and principle of the present invention shall fall within the protection scope of the present invention.

1.-16. (canceled)

17. A method, comprising:
determining a physical resource block for deploying a measurement signal, wherein the physical resource block is a subset of all physical resource blocks in the frequency domain corresponding to a channel bandwidth of a user equipment;
determining a physical resource corresponding to the physical resource block; and
transmitting the measurement signal to the user equipment using the physical resource, wherein the measurement signal is used by the user equipment to measure channel information.

18. The method according to claim 17, further comprising:
sending a resource indication message to the user equipment, wherein the resource indication message indicates the physical resource block for deploying the measurement signal or the physical resource used for transmitting the measurement signal.

19. The method according to claim 18, wherein the resource indication message is a primary synchronization signal (PSS), and a root sequence of the PSS indicates the physical resource block for deploying the measurement signal or the physical resource used for transmitting the measurement signal.

20. The method according to claim 18, wherein the resource indication message is a broadcast message, and the broadcast message indicates the physical resource block for deploying the measurement signal or the physical resource used for transmitting the measurement signal.

21. The method according to claim 17, wherein determining the physical resource block for deploying the measurement signal comprises:
determining, based on a physical resource block for deploying a subsystem, the physical resource block for deploying the measurement signal.

22. The method according to claim 17, wherein the physical resource block comprises at least two physical resource blocks, and the at least two physical resource blocks are consecutively located.

23. The method according to claim 17, wherein the physical resource block comprises at least two physical resource blocks, and the at least two physical resource blocks are located at evenly-spaced locations.

24. The method according to claim 17, wherein the channel information comprises a reference signal received power (RSRP), a received signal strength indicator (RSSI), or a reference signal received quality (RSRQ).

25. A network device, comprising:
a processor, configured to:
determine a physical resource block for deploying a measurement signal, wherein the physical resource block is a subset of all physical resource blocks in the frequency domain corresponding to a channel bandwidth of a user equipment; and
determine a physical resource corresponding to the physical resource block; and
a transmitter, configured to transmit the measurement signal to the user equipment using the physical resource, wherein the measurement signal is used by the user equipment to measure channel information.

26. The network device according to claim 25, wherein the transmitter is further configured to:
send a resource indication message to the user equipment, wherein the resource indication message indicates the physical resource block for deploying the measurement signal or the physical resource used for transmitting the measurement signal.

27. The network device according to claim 26, wherein the resource indication message is a primary synchronization signal (PSS), and a root sequence of the PSS indicates the physical resource block for deploying the measurement signal or the physical resource used for transmitting the measurement signal.

28. The network device according to claim 26, wherein the resource indication message is a broadcast message, and the broadcast message indicates the physical resource block for deploying the measurement signal or the physical resource used for transmitting the measurement signal.

29. The network device according to claim 25, wherein the processor being configured to determine the physical resource block for deploying the measurement signal comprises the processor being configured to:
determine, based on a physical resource block occupied for deploying a subsystem, the physical resource block for deploying the measurement signal.

30. The network device according to claim 25, wherein the physical resource block comprises at least two physical resource blocks, and the at least two physical resource blocks are consecutively located.

31. The network device according to claim 25, wherein the physical resource block comprises at least two physical resource blocks, and the at least two physical resource blocks are located at evenly-spaced locations.

32. The network device according to claim 25, wherein the channel information comprises a reference signal received power (RSRP), a received signal strength indicator (RSSI), or a reference signal received quality (RSRQ).

33. A non-transitory storage medium comprises instructions stored thereon, wherein the instructions are configured to be executed by a computer to:
determine a physical resource block for deploying a measurement signal, wherein the physical resource block for deploying the measurement signal is a subset of all physical resource blocks in the frequency domain corresponding to a channel bandwidth of a user equipment;
determine a physical resource corresponding to the physical resource block; and
transmit the measurement signal to the user equipment using the physical resource, wherein the measurement signal is used by the user equipment to measure channel information.

34. The non-transitory storage medium according to claim 33, wherein the instructions are configured to be further executed by the computer to:
send a resource indication message to the user equipment, wherein the resource indication message indicates the physical resource block for deploying the measurement signal or the physical resource used for transmitting the measurement signal.

35. The non-transitory storage medium according to claim 34, wherein the resource indication message is a primary synchronization signal (PSS), and a root sequence of the PSS indicates the physical resource block for deploying the measurement signal or the physical resource used for transmitting the measurement signal.
